(19) United States
(12) Patent Application Publication
(10) Pub. No.: US 2013/0118203 A1
(43) Pub. Date: May 16, 2013

(54) REFRIGERATOR WITH DISPENSER

(71) Applicant: LG ELECTRONICS INC., Seoul (KR)

(72) Inventors: Woonkyu SEO, Gyeongnam (KR); Seonkyu KIM, Gyeongnam (KR); Seungjin YOON, Gyeongnam (KR); Jungyeon HWANG, Gyeongnam (KR); Daesung LEE, Gyeongnam (KR)

(73) Assignee: LG ELECTRONICS INC., Seoul (KR)

(21) Appl. No.: 13/676,309

(22) Filed: Nov. 14, 2012

(30) Foreign Application Priority Data
Nov. 16, 2011 (KR) 10-2011-0119632

(51) Int. Cl. B67D 3/00; F25D 11/00

(52) U.S. Cl. CPC B67D 3/0058; F25D 11/00
USPC 62/389; 222/189.06; 222/153.14; 222/173

(57) ABSTRACT

A refrigerator includes a refrigeration compartment arranged on an upper side of a main body, a freezer compartment arranged on a lower side of the main body, and a dispenser arranged on a ceiling of the refrigeration compartment to be adjacent to one edge of the ceiling of the refrigeration compartment. The dispenser includes a housing attached to the ceiling of the refrigeration compartment, a water lever provided to the housing such that one side of the water lever is pivotably movable, a discharge valve housed in the housing and connected to the water lever to selectively discharge water according to an operation of the water lever, and a filter unit provided to the housing to filter water.

### REFRIGERATOR WITH DISPENSER

This application claims the benefit of Korean Patent Application No. 10-2011-0119632, filed on Nov. 16, 2011 which is hereby incorporated by reference as if fully set forth herein.

### FIELD

The present disclosure relates to a refrigerator with a dispenser.

### BACKGROUND

A refrigerator is a household appliance which can refrigerate or freeze stored goods using a refrigerant cycle. The refrigerator includes a main body provided with a storage compartment, a door arranged on the main body to open and close the storage compartment, and a dispenser provided at the door to supply drinking water. The dispenser is generally disposed on a front surface of the door of the refrigerator to be exposed to the outside.

### SUMMARY

In one aspect, a refrigerator includes a main body, a refrigeration compartment arranged at the main body, and a dispenser arranged on a ceiling of the refrigeration compartment and configured to supply water. The dispenser includes a housing attached to the ceiling of the refrigeration compartment and a water lever pivotably mounted to the housing such that the water lever is configured to pivot responsive to pressure applied to the water lever. The dispenser also includes a discharge valve housed in the housing and configured to control discharge of water according to operation of the water lever and a filter unit provided to the housing and configured to filter water.

Implementations may include one or more of the features described throughout this disclosure. For example, the dispenser may include a discharge outlet disposed adjacent to the water lever and configured to discharge water. In this example, the water lever and the discharge outlet may be disposed at a front portion of the housing, and the filter unit may be disposed at a rear portion of the housing.

In some implementations, the filter unit may be arranged at a lower side of the housing and may be configured to be detached from the housing and reattached to the housing. In these implementations, the filter unit may be connected to at least one of an external water source and a water tank arranged on the main body.

In addition, the water lever may be vertically oriented, may be spaced a distance from a sidewall of the refrigeration compartment, and may be arranged to be parallel to the sidewall of the refrigeration compartment when external pressure is not applied to the water lever.

In some examples, the refrigerator may include a locking unit arranged on the housing and configured to selectively limit pivotal movement of the water lever. In these examples, the locking unit may be configured to slide between a locked position at which the locking unit contacts the water lever to limit pivotal movement of the water lever and an unlocked position at which the locking unit is spaced from the water lever to allow the water lever to pivot.

Further, the locking unit may be disposed on a front surface of the housing and may be accessible by a user positioned in front of the refrigeration compartment. At a locked position in which the locking unit limits the pivotal movement of the water lever, the locking unit may be positioned lower than a support of the water lever and may contact a side of the water lever. At an unlocked position in which the locking unit allows the water lever to pivot, the locking unit may be positioned higher than the support of the water lever and may be spaced from the water lever.

In some implementations, the refrigerator may include a guide slot configured to guide sliding movement of the locking unit. In these implementations, the locking unit may include a contact arranged in the housing and configured to contact the water lever and a knob arranged outside of the housing, connected through the guide slot to the contact, and configured to move the contact based on sliding of the knob.

In another aspect, a refrigerator includes a refrigeration compartment, at least one door configured to open and close the refrigeration compartment, and a dispenser arranged on a ceiling of the refrigeration compartment and configured to supply water. The dispenser is covered by the at least one door when the at least one door is oriented in a closed position that closes the refrigeration compartment and the dispenser is exposed when the at least one door is oriented in an open position that opens the refrigeration compartment.

Implementations may include one or more of the features described throughout this disclosure. For example, the dispenser may be spaced from the at least one door. The dispenser also may be fixed in the refrigeration compartment, regardless of movement of the at least one door.

In some implementations, the dispenser may be disposed adjacent to an edge of the ceiling of the refrigeration compartment. In these implementations, the dispenser may be arranged in the refrigeration compartment, at a position around where the at least one door is coupled to the refrigeration compartment.

Further, the at least one door may pivot around an end of the refrigeration compartment. The at least one door may include two doors, each of which may be coupled to an end of the refrigeration compartment.

In some examples, the dispenser may include a housing attached to the ceiling of the refrigeration compartment and a water lever pivotably mounted to the housing such that the water lever is configured to pivot responsive to pressure applied to the water lever. In these examples, the dispenser may include a discharge valve housed in the housing and configured to control discharge of water according to operation of the water lever and a filter unit provided to the housing and configured to filter water.

In yet another aspect, a refrigerator includes a main body, a refrigeration compartment arranged at a first portion of the main body, and a freezer compartment arranged at a second portion of the main body that is different from the first portion of the main body. The refrigerator also includes at least one door configured to open and close the refrigeration compartment, a dispenser arranged on a ceiling of the refrigeration compartment and configured to supply water, and a conduit that passes through the main body and connects the dispenser to at least one of an external water source and a water tank arranged on the main body.

Implementations may include one or more of the features described throughout this disclosure. For example, the conduit may not pass through the at least one door.

The details of one or more implementations are set forth in the accompanying drawings and the description below. Other features will be apparent from the description and drawings, and from the claims.

### BRIEF DESCRIPTION OF THE DRAWINGS

FIG. 1 is a front view illustrating an example refrigerator with doors open.

FIG. 2 is a perspective view illustrating arrangement of an example dispenser.

FIG. 3 is an exploded perspective view illustrating the example dispenser.

FIGS. 4A and 4B are front views illustrating discharge of water from the example dispenser.

FIGS. 5A and 5B are front views illustrating the example dispenser with drinking water stopped from being discharged.

### DETAILED DESCRIPTION

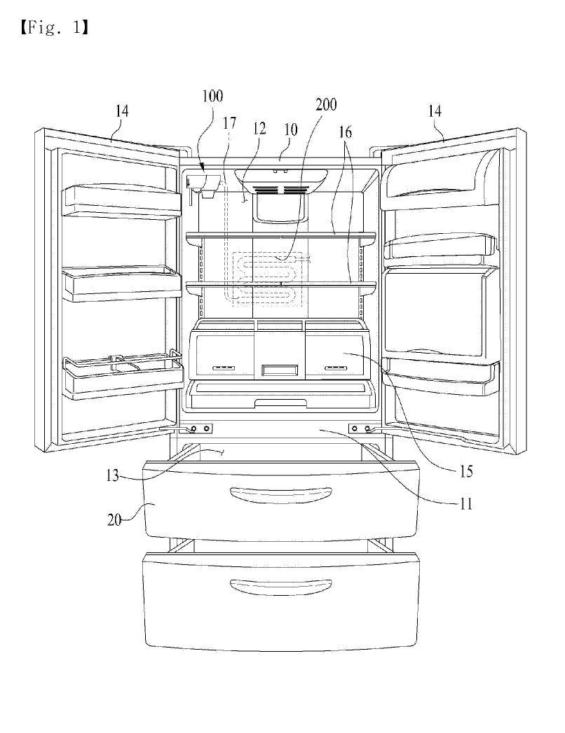

FIG. 1 illustrates an example refrigerator. As shown in FIG. 1, the refrigerator includes a main body 10, refrigeration and freezer compartments 12 and 13 provided in the main body 10, and doors 14 and 20 for opening and closing the refrigeration and freezer compartments 12 and 13, respectively.

The refrigeration compartment 12 is opened and closed by two doors 14, respectively arranged to be pivotably movable around opposite lateral ends of the main body 10. That is, when the refrigeration compartment 12 is opened by rotating the two doors 14, a user may access the inside of the refrigeration compartment 12. Because no obstruction exists in the middle of the refrigeration compartment 12, the full width of the refrigeration compartment 12 is available for storage of food items.

The refrigeration compartment 12 and the freezer compartment 13 are separated from each other by a partition wall 11 provided therebetween. A storage drawer 15 and a shelf 16 are provided in the refrigeration compartment 12.

Also, provided at an upper side of the inside of the refrigeration compartment 12 is a dispenser 100 for supplying drinking water.

In some implementations, the dispenser 100 is attached to the ceiling of the refrigeration compartment 12 adjacent to one edge of the ceiling of the refrigeration compartment 12, while being spaced a predetermined distance from a sidewall of the refrigeration compartment 12.

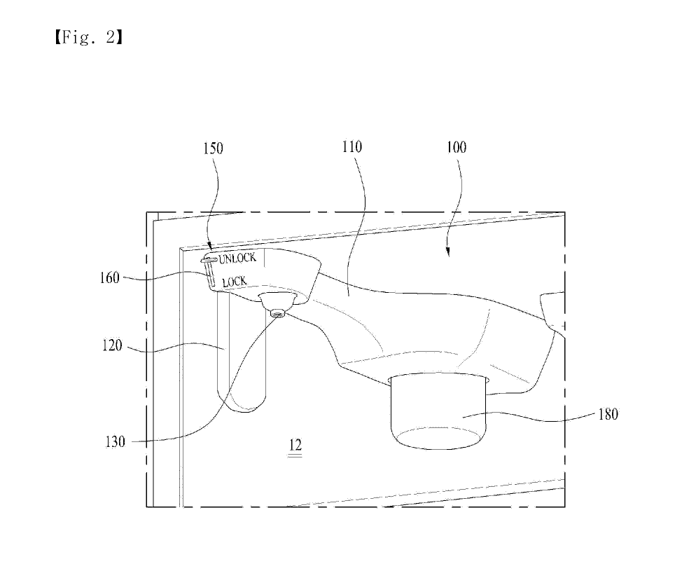

This arrangement of the dispenser 100 is allows a water lever 120 (see FIG. 2), which will be described below, to be pressed without contacting the sidewall of the refrigeration compartment 12.

In addition, the dispenser 100 may be disposed relatively close to a position where one of the doors 14 is coupled to the main body 10. The dispenser 100 may be disposed close to one of the doors 14 with a predetermined distance from one of the doors 14, without contacting the doors 14.

In some examples, the dispenser 100 is disposed near a corner of the refrigeration compartment 12, rather than a center of the refrigeration compartment 12. Hence, the possibility of causing inconvenience to a user may be reduced when a user accesses the inside of the refrigeration compartment 12 after opening the doors 14. Moreover, the possibility of unintended operation of the dispenser 100 may be reduced when the user retrieves stored food from the refrigeration compartment 12.

In the example shown in FIG. 1, when the doors are closed by the user to shut the refrigeration compartment 12, the dispenser 100 is not exposed to the user. When the doors 14 are opened, the dispenser 100 is exposed to the user.

Further, the dispenser 100 is arranged to be spaced from the doors 14. That is, since the dispenser 100 does not contact the doors 14, the dispenser 100 is kept fixed in the refrigeration compartment 12, regardless of rotational movement of the doors 14. Therefore, a flow path for supplying water to the dispenser 100 may be kept fixed, and stabler water supply may be achieved.

A water tank 200 may be arranged at the rear side of the refrigeration compartment 12 to store water to be supplied to the dispenser 100 so that water can be supplied when the dispenser 100 is operated.

The dispenser 100 also may be supplied with water from a separate external water source.

A conduit 17 through which water is supplied from the external water source or the water tank 200 to the dispenser 100 may be embedded in the main body 10 outside the refrigeration compartment 12. Accordingly, the conduit 17 is not exposed to the user even when opening the doors 14.

With the dispenser 100 installed in the refrigeration compartment 12, the conduit 17 may connect the external water source or the water tank 200 with the dispenser 100, without passing through the doors 14. Therefore, the length of the flow path for supplying water to the dispenser 100 may be reduced as compared to a dispenser positioned on a refrigerator door.

Further, since the conduit 17 does not pass through the doors 14, the conduit 17 does not move during rotation of the doors 14. Therefore, water leakage resulting from frequent movement of the conduit 17 may be reduced.

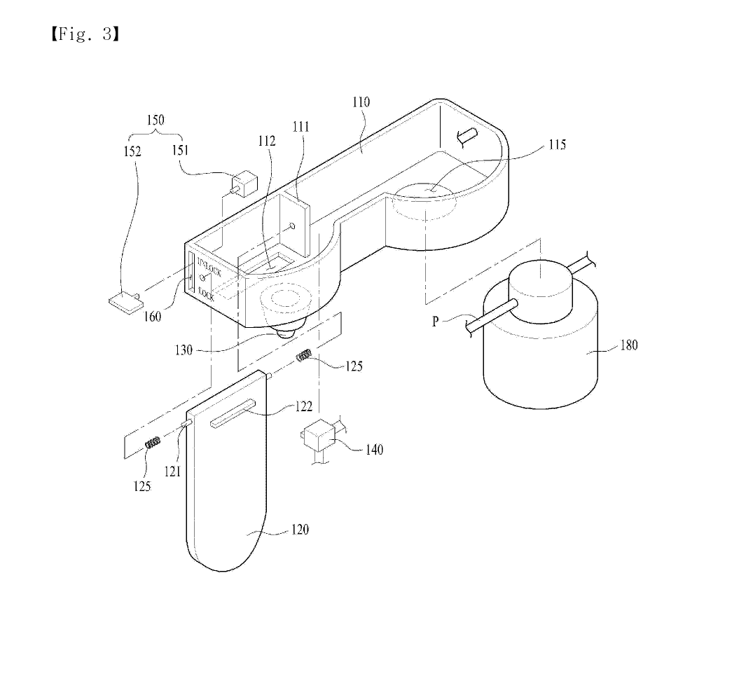

As shown in FIG. 2, the dispenser 100 includes a housing 110 forming an appearance of the dispenser 100, the water lever 120 arranged on a front lower side of the housing 110, a discharge outlet 130 arranged at one side of the water lever 120 to discharge water, a discharge valve 140 (see FIG. 3) arranged in the housing 110, and a locking unit 150 arranged in the housing 110 at one side of the water lever 120 to selectively limit pivotal movement of the water lever 120.

The locking unit 150 is arranged to slidably move up and down on the front surface of the housing 110, which is provided with a guide slot 160 for guiding vertical movement of the locking unit 150.

The locking unit 150 is disposed on the front side of the housing to face forward, so that when the user opens the refrigeration compartment 12, the user can easily access the locking unit 150 to operate the locking unit 150, while standing in front of the refrigeration compartment 12.

Further, a filter unit 180 is arranged on a rear lower side of the housing 110 to filter water to be delivered to the discharge valve 140.

As shown in FIG. 3, the housing 110 is provided with an open top and attached to the ceiling of the refrigeration compartment 12 (see FIG. 1).

A support wall 111 is provided at the housing 110 such that protrusion-shaped supports 121 arranged at both upper ends of the water lever 120 are pivotably coupled to the support wall 111 and the inner surface of the front wall of the housing 110, respectively.

With such a configuration, the water lever 120 is pivotably supported by the housing 110. In addition, elastic members 125 are provided at the supports 121 such that the water lever 120 is returned to its original position by the elastic resilience of the elastic members 125 when the pressure pivotably rotating the water lever 120 is released.

The water lever 120 is vertically disposed and has the shape of a pedal with a pivotably supported upper end.

The water lever 120 also is spaced from the sidewall of the refrigeration compartment 12, so that pivotal movement of the water lever 120 may not be interfered with by collision against the sidewall of the refrigeration compartment 12.

In some implementations, the water lever 120 is arranged parallel to the sidewall of the refrigeration compartment 12 when not operated to discharge water.

A pivot slot 112 for defining the range of movement of the water lever 120 is arranged at the bottom of the housing 110.

Accordingly, an upper portion of the water lever 120 positioned higher than the pivot slot 112 is housed in the housing 110, while a lower portion of the water lever 120 positioned lower than the pivot slot 112 is exposed to the outside beneath the housing 110.

The discharge outlet 130 is arranged on one side of the water lever 120, and a discharge valve 140 is arranged over the upper side of the discharge outlet 130.

The discharge valve 140 may be arranged to contact or be connected to a rib 122 of the water lever 120 to guide or block flow of water toward the discharge outlet 130 depending on pivotal movement of the water lever 120.

The discharge valve 140 is connected to the filter unit 180 by a water conduit P.

The filter unit 180 is adapted to filter drinking water before the drinking water is delivered to the discharge valve 140. Provided at the housing 110 is a mounting hole 115 where the filter unit 180 is mounted. The filter unit 180 is detachably disposed in the mounting hole 115.

An upper portion of the filter unit 180 is firmly fitted into the mounting hole 115, while a lower portion of the filter unit 180 is arranged under the mounting hole 115 to be exposed.

The filter unit 180 may be connected directly to the external water source or connected to the water tank 200 (see FIG. 1) arranged in the main body 10.

The locking unit 150 includes a contact 151 arranged to contact the water lever 120, and a knob 152 connected to the contact 151 and exposed to the outside of the housing 110.

A guide slot 160 is provided at the front side of the housing 110 to guide vertical movement of the contact 151 and the knob 152. A connector for connecting the contact 151 to the knob 152 is disposed to pass through the guide slot 160.

When the water lever 120 moves pivotably toward one side of the refrigeration compartment 12, particularly toward one sidewall of the refrigeration compartment 12, it operates the discharge valve 140 to discharge water. Meanwhile, the locking unit 150 exerts a restrictive force on the water lever 120 to limit pivotal movement of the water lever 120, thereby stopping water discharge due to unintended operation of the water lever 120.

When limiting the pivotal movement of the water lever 120, the locking unit 150 is positioned lower than the supports 121 of the water lever 120 to contact one side of the water lever 120, and when allowing the water lever 120 to pivotably move, the locking unit 150 is positioned higher than the supports 121 of the water lever 120 to be spaced from the water lever.

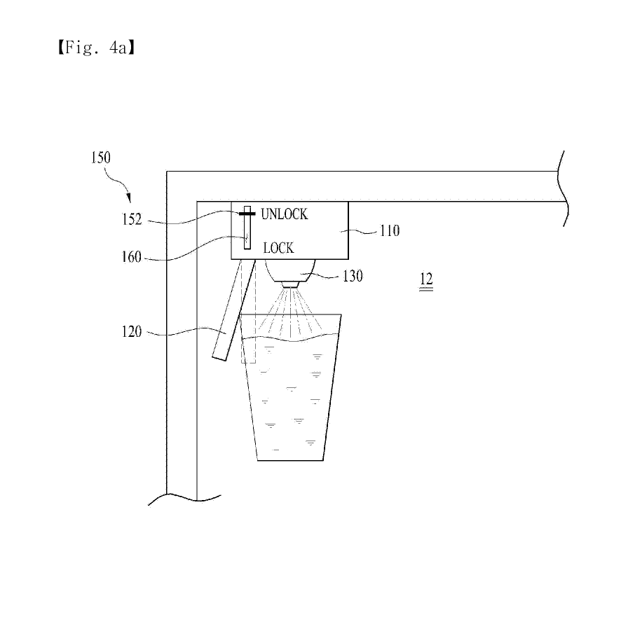

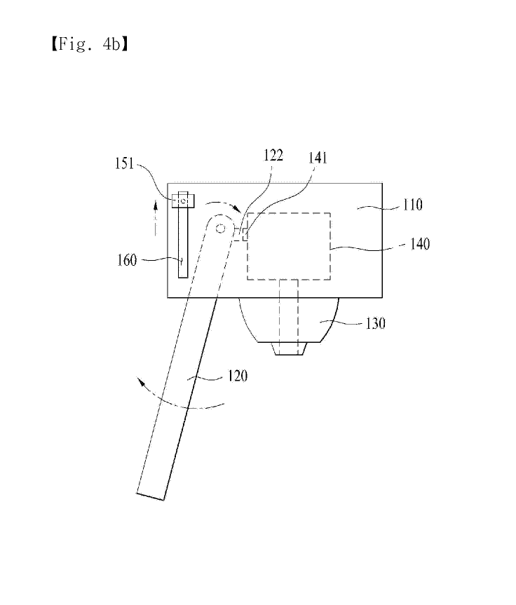

As shown in FIGS. 4A and 4B, when the knob 152 of the locking unit 150 is placed at an unlocking position UNLOCK on the upper portion of the guide slot 160, the contact 151 is positioned higher than the supports 121 of the water lever 120 and spaced from the water lever 120.

Accordingly, the water lever 120 can freely pivot when the water lever 120 is pressed.

When the water lever 120 is pressed, the rib 122 arranged on the water lever 120 applies pressure to a switch 141 of the discharge valve 140.

When the switch 141 is pressed, the switch 141 opens the water conduit such that drinking water is guided through the water conduit to the discharge outlet 130 and discharged from the discharge outlet 130, and the discharged water falls into a cup or a container which is applying pressure to the water lever 120.

Thereafter, when the pressure applied to the water lever 120 is released, the water lever 120 returns to an original position by the elastic resilience of the elastic members 125 (see FIG. 3), and the water lever 120 stops applying pressure to the switch 141.

Thereby, the discharge valve 140 blocks flow of the drinking water from the water conduit to the discharge outlet 130 to stop the drinking water from flowing out of the discharge outlet 130.

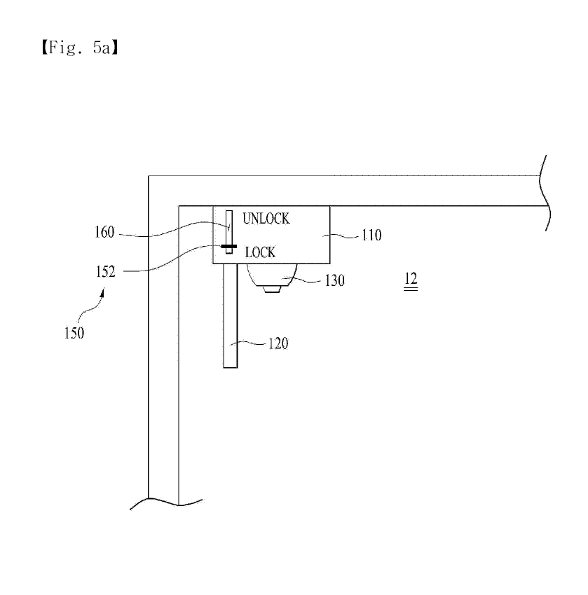

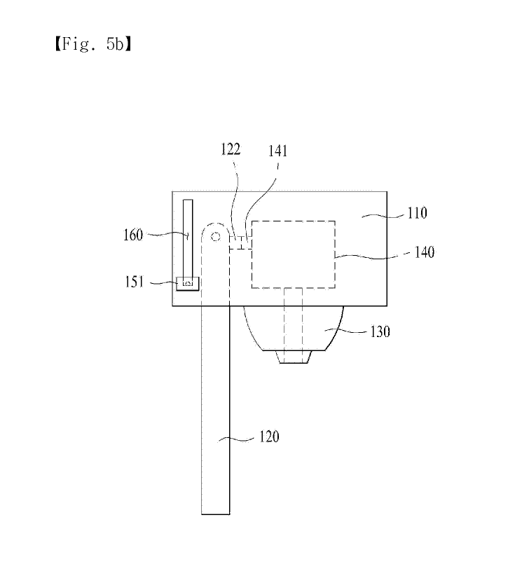

As shown in FIGS. 5A and 5B, when the locking unit 150 and the knob 152 are placed at a locking position LOCK on a lower portion of the guide slot 160, the contact 151 is positioned lower than the supports 121 of the water lever 120 and comes into contact with the water lever 120.

Thereby, pivotal movement of the water lever 120 is limited.

Accordingly, the water lever 120 restricted from pivoting even if the user presses the water lever 120, and thus the rib 122 does not press the switch 141 of the discharge valve 140.

Therefore, when the locking unit 150 is placed in the LOCK position, the discharge valve 140 does not operate because the water lever 120 is restricted from moving responsive to pressure applied to the water lever 120. Thus, the drinking water may be blocked from being discharged from the discharge outlet 130.

In some examples, the refrigerator provides a more integrated outward appearance to the refrigerator by arranging the dispenser inside the refrigerator.

Also, since a locking unit for limiting operation of the water lever is provided to the dispenser, unintended discharge of water may be reduced when the dispenser is not used or a child presses the water lever by mistake.

In addition, by disposing the dispenser on the ceiling of the refrigeration compartment, the inner space of the refrigeration compartment remains available, even with the dispenser equipped in the refrigeration compartment.

Further, since the dispenser itself is spaced from the sidewall, collision between the water lever and the sidewall of the refrigeration compartment when the water lever pivotably moves toward the sidewall of the refrigeration compartment may not occur.

It will be apparent to those skilled in the art that various modifications and variations can be made without departing from the spirit or scope of the disclosure. Thus, it is intended that the present disclosure covers the modifications and variations.

What is claimed is:

1. A refrigerator comprising;
a main body;
a refrigeration compartment arranged at the main body; and
a dispenser arranged on a ceiling of the refrigeration compartment and configured to supply water, the dispenser comprising:
a housing attached to the ceiling of the refrigeration compartment;
a water lever pivotably mounted to the housing such that the water lever is configured to pivot responsive to pressure applied to the water lever;
a discharge valve housed in the housing and configured to control discharge of water according to operation of the water lever; and
a filter unit provided to the housing and configured to filter water.

2. The refrigerator according to claim 1, wherein the dispenser comprises a discharge outlet disposed adjacent to the water lever and configured to discharge water,
wherein the water lever and the discharge outlet are disposed at a front portion of the housing, and the filter unit is disposed at a rear portion of the housing.

3. The refrigerator according to claim 2, wherein the filter unit is arranged at a lower side of the housing and is configured to be detached from the housing and reattached to the housing.

4. The refrigerator according to claim 3, wherein the filter unit is connected to at least one of an external water source and a water tank arranged on the main body.

5. The refrigerator according to claim 2, wherein the water lever is vertically oriented, spaced a distance from a sidewall of the refrigeration compartment, and arranged to be parallel to the sidewall of the refrigeration compartment when external pressure is not applied to the water lever.

6. The refrigerator according to claim 2, further comprising a locking unit arranged on the housing and configured to selectively limit pivotal movement of the water lever.

7. The refrigerator according to claim 6, wherein the locking unit is configured to slide between a locked position at which the locking unit contacts the water lever to limit pivotal movement of the water lever and an unlocked position at which the locking unit is spaced from the water lever to allow the water lever to pivot.

8. The refrigerator according to claim 6, wherein the locking unit is disposed on a front surface of the housing and is accessible by a user positioned in front of the refrigeration compartment.

9. The refrigerator according to claim 8, wherein, at a locked position in which the locking unit limits the pivotal movement of the water lever, the locking unit is positioned lower than a support of the water lever and contacts a side of the water lever, and at an unlocked position in which the locking unit allows the water lever to pivot, the locking unit is positioned higher than the support of the water lever and is spaced from the water lever.

10. The refrigerator according to claim 9, further comprising a guide slot configured to guide sliding movement of the locking unit,
wherein the locking unit comprises:
a contact arranged in the housing and configured to contact the water lever; and
a knob arranged outside of the housing, connected through the guide slot to the contact, and configured to move the contact based on sliding of the knob.

11. A refrigerator comprising;
a refrigeration compartment;
at least one door configured to open and close the refrigeration compartment; and
a dispenser arranged on a ceiling of the refrigeration compartment and configured to supply water, the dispenser being covered by the at least one door when the at least one door is oriented in a closed position that closes the refrigeration compartment and the dispenser being exposed when the at least one door is oriented in an open position that opens the refrigeration compartment.

12. The refrigerator according to claim 11, wherein the dispenser is spaced from the at least one door.

13. The refrigerator according to claim 11, wherein the dispenser is fixed in the refrigeration compartment, regardless of movement of the at least one door.

14. The refrigerator according to claim 11, wherein the dispenser is disposed adjacent to an edge of the ceiling of the refrigeration compartment.

15. The refrigerator according to claim 14, wherein the dispenser is arranged in the refrigeration compartment, at a position around where the at least one door is coupled to the refrigeration compartment.

16. The refrigerator according to claim 11, wherein the at least one door pivots around an end of the refrigeration compartment.

17. The refrigerator according to claim 16, wherein the at least one door comprises two doors, each of which is coupled to an end of the refrigeration compartment.

18. The refrigerator according to claim 11, wherein the dispenser comprises:
a housing attached to the ceiling of the refrigeration compartment;
a water lever pivotably mounted to the housing such that the water lever is configured to pivot responsive to pressure applied to the water lever;
a discharge valve housed in the housing and configured to control discharge of water according to operation of the water lever; and
a filter unit provided to the housing and configured to filter water.

19. A refrigerator comprising;
a main body;
a refrigeration compartment arranged at a first portion of the main body;
a freezer compartment arranged at a second portion of the main body that is different from the first portion of the main body;
at least one door configured to open and close the refrigeration compartment;
a dispenser arranged on a ceiling of the refrigeration compartment and configured to supply water; and
a conduit that passes through the main body and connects the dispenser to at least one of an external water source and a water tank arranged on the main body.

20. The refrigerator according to claim 19, wherein the conduit does not pass through the at least one door.
